(19) United States
(12) Patent Application Publication
(10) Pub. No.: US 2008/0057876 A1
(43) Pub. Date: Mar. 6, 2008

(54) METHOD FOR CONTROLLING HANDHELD COMMUNICATION APPARATUS

(75) Inventors: Ting-Pang Hsia, Taipei (TW); Chien-Yu Lin, Taipei (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, omitted

(73) Assignee: INVENTEC APPLIANCES CORP., Taipei (TW)

(21) Appl. No.: 11/838,232

(22) Filed: Aug. 14, 2007

(30) Foreign Application Priority Data
Aug. 29, 2006 (TW) 95131701

(51) Int. Cl. H04B 7/00

(52) U.S. Cl. 455/69

(57) ABSTRACT

A method for controlling handheld communication apparatus is disclosed. In the method, a first radio frequency (RF) signal is transmitted from the handheld communication apparatus to a radio frequency identification (RFID) tag, and then a second RF signal responded by the RFID tag is received by the handheld communication apparatus. On the other hand, a third RF signal directly emitted from a RFID tag can also be received by the handheld communication apparatus. According to the second RF signal or the third RF signal, a control command is identified by the handheld communication apparatus. Finally, an action corresponding to the control command is executed by the handheld communication apparatus.

### CROSS-REFERENCE TO RELATED APPLICATION

This application claims the priority benefit of Taiwan application serial no. 95131701, filed Aug. 29, 2006. All disclosure of the Taiwan application is incorporated herein by reference.

### BACKGROUND OF THE INVENTION

1. Field of the Invention

The present invention relates to a method for controlling a handheld communication apparatus, more specifically, relates to a method for using a Radio Frequency Identification (RFID) Tag to control a handheld communication apparatus.

2. Description of Related Art

Nowadays, many handheld communication apparatuses, such as cellular phones and personal digital assistants (PDAs), are developed. These apparatuses enable modern people to communicate at any time and anywhere, and in the mean time, these apparatuses also become important necessities that modern people cannot live without.

Although these handheld apparatuses enable people to enjoy the convenience of communication life, however, in some specific places, users have to follow rules to turn their handheld apparatuses into a silent mode. For example, in theaters the speaker of a cellular phone has to be turned off to avoid the cellular phone from ringing suddenly and disturbing others.

However, at present, the operating procedures of some handheld apparatuses are too complicated, which result in that some of the users don't know how to switch their devices to the silent mode, or, even turn their apparatuses off due to the complicated operation. Therefore, when people enter the above specific places, they usually turn off their handheld communication apparatuses. However, such practice will totally keep the user from receiving outside communications, and in case that an important call or message comes in, it may cause losses or inconvenience for the user due to missing answering the call. In addition, the handheld apparatuses may disturb others in specific places because the user might forget to turn off the handheld apparatuses due to negligence.

On the other hand, since handheld communication apparatus may emit strong electromagnetic wave during communication, to avoid such electromagnetic wave to interfere communication devices of planes and harm the flight safety, currently all countries have regulations requiring that passengers must turn off their cellular phones and the alike handheld communication apparatuses to avoid dangers.

At present, when aircrafts take off or land, although flight attendants may remind passengers to turn off their handheld communication apparatuses like cellular phones via broadcasting or video clips, however, unavoidably some passengers might still forget by negligence, such that at present unpredictable danger still exists with such practice. Moreover, passengers have to turn off cellular phones before taking off, turn on and use cellular phones during the flight, and turn off cellular phones again when landing, such repeatedly turn cellular phones on and off may cause inconvenience for users.

### SUMMARY OF THE INVENTION

The present invention is directed to a handheld communication apparatus control method, by which when user's handheld communication apparatus enters specific places, the handheld communication apparatus is turned into a silent mode or turned off directly in time to avoid disturbing the quietness or harming the safety of the specific places.

The present invention is directed to a handheld communication apparatus control method, so that user's handheld communication apparatus is automatically turned back to a normal mode when user's handheld communication apparatus leaves the specific places, thus providing convenience for user's operation.

The present invention provides a handheld communication apparatus control method suitable for handheld communication apparatuses. The control method includes that the handheld communication apparatus transmits a first RF signal to a radio frequency identification (RFID) tag. Next, after receiving the first RF signal, the RFID Tag transmits a second RF signal. Then the handheld communication apparatus receives the second RF signal. According to the second RF signal, the handheld communication apparatus obtains a control command. Lastly, the handheld communication apparatus executes the action corresponding to the control command. Wherein, the RFID tag includes a passive RFID tag.

According to the handheld communication apparatus control method, wherein the step of obtaining the control commands includes that the handheld communication apparatus translates the second RF signal into an identification code. Next, the handheld communication apparatus searches for a control command corresponding to the identification code in its internal database.

According to the handheld communication apparatus control method, wherein the step of obtaining the control command includes that the handheld communication apparatus directly translates the second RF signal into an identification code.

According to the handheld communication apparatus control method, wherein the handheld communication apparatus transmits the first RF signal continuously, or transmits the first RF signal every a predetermined time interval.

According to the handheld communication apparatus control method, wherein the predetermined time interval is between 1 second to 10 seconds.

According to the handheld communication apparatus control method, wherein the method of executing the actions includes turning on/off the speaker of the handheld communication apparatus or turning off the handheld communication apparatus.

According to the handheld communication apparatus control method, wherein the frequencies of the first RF signal and the second RF signal are between 125 KHz to 2.5 GHz.

According to the handheld communication apparatus control method, wherein the handheld communication apparatus includes cellular phones, smart phones or personal digital assistants (PDAs).

The present invention further provides a handheld communication apparatus control method. The method includes that the handheld communication apparatus receives a third RF signal transmitted actively by the RFID tag. Then, according to the third RF signal, the handheld communication apparatus obtains a control command and executes the action corresponding to the control command. Wherein, the RFID tag includes an active RFID tag.

According to the handheld communication apparatus control method, wherein the step of obtaining the control command includes that the handheld communication apparatus translates the third RF signal into the identification code. Next, the handheld communication apparatus searches for a control command corresponding to the identification code in its internal database.

According to the handheld communication apparatus control method, wherein the step of obtaining the control commands includes that the handheld communication apparatus directly translates the third RF signal as the identification code.

According to the handheld communication apparatus control method, wherein the RFID tag transmits the third RF signals continuously, or transmits the third RF signal every a predetermined time interval.

According to the handheld communication apparatus control method, wherein the predetermined time interval includes the intervals between 1 second to 10 seconds.

According to the handheld communication apparatus control method, wherein the method of executing the action includes turning on/off the speaker of the handheld communication apparatus or turning off the handheld communication apparatus.

According to the handheld communication apparatus control method, wherein the frequency of the third RF signal is between 125 KHz and 2.5 GHz.

According to the handheld communication apparatus control method, wherein the handheld communication apparatus includes cellular phones, smart phones or personal digital assistants (PDAs).

Through using the RF signals transmitted by the RFID tag to control the handheld communication apparatus, so that the present invention can adjust the handheld communications apparatus to silent mode or turn off the handheld communications apparatus when the handheld communications apparatus enters or leaves specific places, such as concert halls, cinemas, theaters or aircrafts in a timely manner, so as to ensure that they do not disturb the quietness of the places, or endanger flight safety.

In order to the make the aforementioned and other objects, features and advantages of the present invention comprehensible, a preferred embodiment accompanied with figures is described in detail below.

### BRIEF DESCRIPTION OF THE DRAWINGS

FIG. 1 is a flow chart illustrating a handheld communication apparatus control method according to the first embodiment of the present invention.

FIG. 2 is a flow chart illustrating a handheld communication apparatus control method according to the second embodiment of the present invention.

FIG. 3 is a flow chart illustrating a control method of a cellular phone according to the third embodiment of the present invention.

FIG. 4 is a flow chart illustrating a cellular phone control method according to the fourth embodiment of the present invention.

FIG. 5 is a flow chart illustrating a cellular phone control method according to the fifth embodiment of the present invention.

### DESCRIPTION OF EMBODIMENTS

The present invention achieves the object of controlling the handheld communications apparatus through the RFID tag. Generally a RFID tag needs a reader to receive and translate the RF signals transmitted by the RFID tag, the present invention is first to use a reader to receive the RF signals transmitted by the RFID tag, and to obtain the control command from the RF signal to control the handheld communications apparatus to execute the actions according to the control command. In order to make the content of the present invention clearer, the steps will be detailed using the embodiments and drawings.

### The First Embodiment

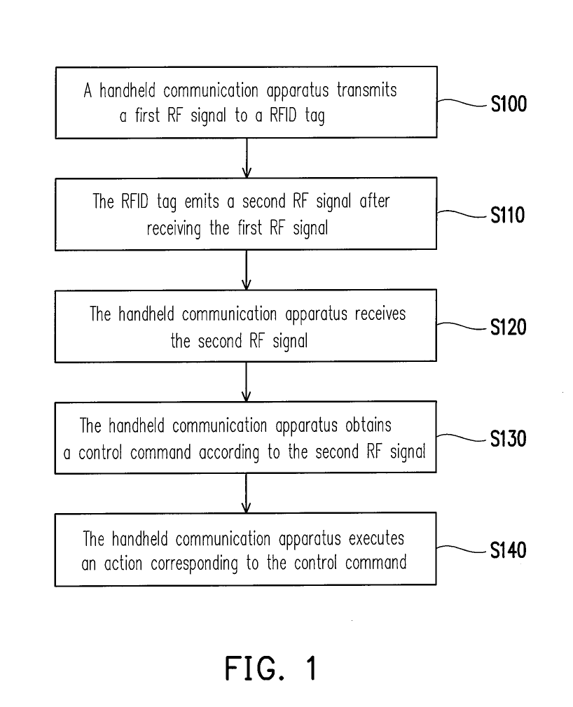

FIG. 1 is a flow chart illustrating the handheld communication apparatus control method according to the first embodiment of the present invention. Referring to FIG. 1, in the present embodiment, the handheld communication apparatus includes cellular phones, smart phones or PDA phones. And the places to where the present embodiment is adapted include cinemas, concert halls, theaters, hospitals, medical clinics, wards, meeting rooms, airplanes and airports. And the applicable time includes when users bring handheld communications apparatuses to enter or leave the places.

The handheld communication apparatus control method of the present invention includes the following steps. First, the handheld communication apparatus transmits a first RF signal to a RFID tag (S100). Next, after receiving the first RF signal, the RFID Tag then transmits a second RF signal (S110). The first and the second RF signals both are a type of electromagnetic wave signal, and the operation frequency of the RFID tag includes frequencies between 125 KHz and 2.5 GHz, i.e. the frequencies of the first and the second RF signals are also between 125 KHz and 2.5 GHz.

The operation frequencies can be further Classified into ranges of low frequency (125˜135 KHz), high frequency (13.56 MHz), ultra-high frequency (100˜960 MHz) and microwave (2.45 GHz) and etc. The handheld communication apparatus, for example cellular phone itself may transmit radio wave signals. For example, a regular GSM (Global System of Mobile communication) three-frequency cellular phone, the frequencies of the radio signals it transmits include 900 MHz, 1800 MHz and 1900 MHz, wherein the frequency range of 900 MHz falls within the operation range of the RFID tag of the ultra-high frequency. Therefore the handheld communication apparatus may directly use the radio signals of itself as the first RF signal.

After the handheld communication apparatus transmits the first RF signal to the RFID tag, the RFID tag will then transmits the second RF signal correspondingly. Specifically, the RFID tag may be a passive RFID tag. When the RFID tag is receiving the first RF signal, an electromagnetic induction method is used to generate current, and further the second RF signal is transmitted.

As for the method of transmitting the first RF signal to the RFID tag, a handheld communications apparatus may transmits the first RF signals to the RFID tag continuously, or, a handheld communications devices may also transmits the first RF signals to the RFID tag every a predetermined time interval which can be set by users themselves, for example between 1 second and 10 seconds, so as to save the power consumed by the handheld communications apparatus when transmitting the first RF signals.

Next, the handheld communications apparatus receives the second RF signal transmitted from the RFID tag (S120). Then, according the second RF signal, the handheld communication apparatus obtains a control command (S130). Wherein the method of obtaining the control command includes the following steps: first, the handheld communication apparatus translates the second RF signal into the identification code; next, the handheld communication apparatus searches for the control command corresponding to the identification code in its internal database. Specifically, when the RFID tag transmits the second RF signal, the content of the second RF signal includes the identification code. After the handheld communication apparatus receives the second RF signal, the handheld communication apparatus translates the same to obtain the identification code. There is a database in the handheld communication apparatus, the database records different identification codes and control commands corresponding to different identification codes. After translating the identification code, the handheld communication apparatus searches for the control command corresponding to the identification code in its internal database right away.

Of course, other than the above method of obtaining the control command, the present embodiment also includes other methods of obtaining the control command, for example, the handheld communication apparatus directly translates the second RF signal into the control command. In other words, the control command has already included in the content of the second RF signal transmitted by the RFID tag. When receiving the second RF signal, the handheld communication apparatus then translates the same to obtain the control command. Thus, the handheld communication apparatus does not have to search the database, instead, it can obtain the control command from the RFID tag directly.

Lastly, the handheld communication apparatus may execute the actions according to the control command (S140). Wherein the above actions include turning off the speaker of the handheld communication apparatus, turning on the speaker or turning off the handheld communication apparatus. Therefore, the handheld communication apparatus can be ensured to be in a silent mode or an off mode when a user enters or leaves above places with the handheld communication apparatus. Thus, the disturbance to the quietness of places or the influence of flight safety can be prevented.

### The Second Embodiment

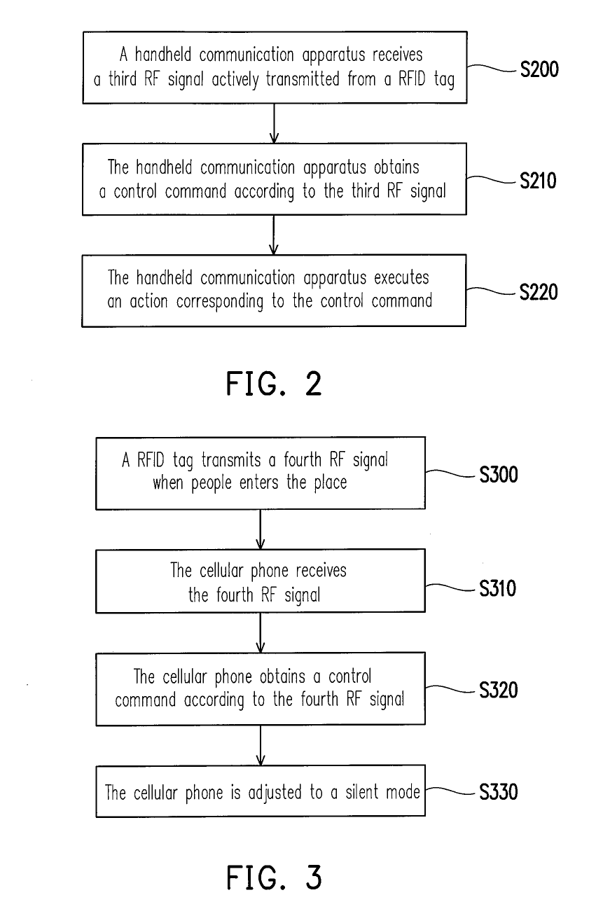

FIG. 2 is a flow chart illustrating the handheld communication apparatus control method according to the second embodiment of the present invention. Referring to FIG. 2, the related art of the present embodiment is roughly the same as that of the first embodiment, and the only difference is that different RFID tags are used by these two embodiments. The second embodiment uses, for example, an active RFID tag as the RFID tag.

The method of the present embodiment includes following steps: first, the handheld communication apparatus receives a third RF signal transmitted by the RFID tag actively (S200). The active RFID tag has a battery, so the active RFID tag can transmit the third RF signals with the battery power. In addition, signal transmitting distance of the active RFID tag is longer than that of the passive RFID tag. It is worth to mention that the operation frequency of the active RFID tag is higher, usually falls within the range of ultra high frequency (100˜960 MHz) and microwave (2.45 GHz). Therefore, similarly, the third RF signal may also be received through a radio signal receiver of the handheld communication apparatus itself.

As for the method that the RFID tag transmits the third RF signal, for example is to transmit continuously or transmits every predetermined time interval. Since the prior art thereof is the same as that of the previous embodiment, therefore will not be repeated herein. However, the difference is that the third RF signal is transmitted actively by the RFID tag, in stead of being transmitted by the handheld communication apparatus.

Next, when the third RF signal is received, the handheld communication apparatus obtains the control command (S210) basing on the third RF signal. Wherein, the method of obtaining the control command is, for example, to translate the third RF signal into the identification code or to translate it into the control command directly. Since the related art thereof is as the same as that of the previous embodiment, therefore will not be repeated herein.

Finally, the handheld communication apparatus executes the action according to the control command (S220). Wherein, the actions, which are same as the previous embodiment, include switching the handheld communication apparatus to a silent mode, returning it to a normal mode or turning it off. Thus, users can bring handheld communication apparatuses to enter or leave specific places such as cinemas or concert halls with peace of mind, without worrying the handheld communication apparatus may ring suddenly. Thus the quietness in specific places can be assured, or flight accident can be avoided.

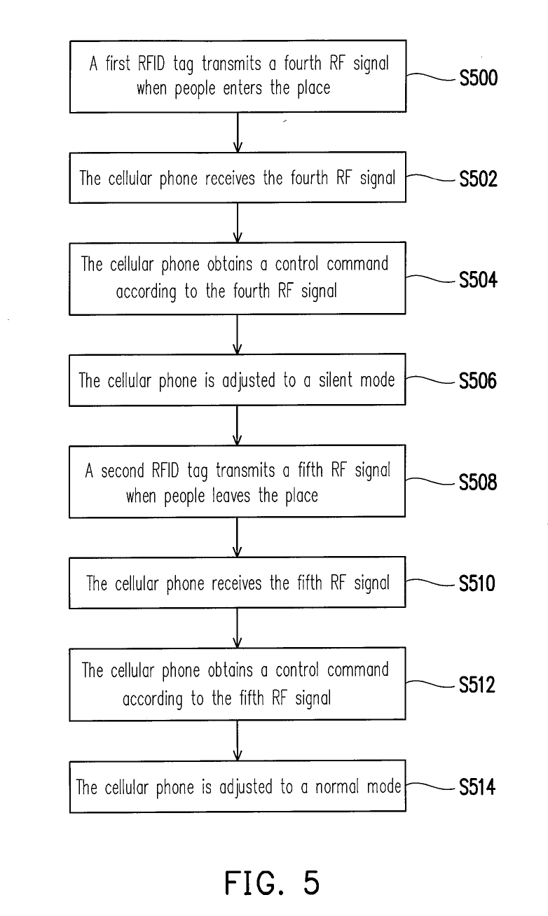

In order to detail how the present invention is applied in modern daily life, next, three embodiments and FIG. 3˜FIG. 5 will be used as the examples to reveal the spirits, features and methods of the present invention with more details.

### The Third Embodiment

FIG. 3 is a flow chart illustrating a control method of a cellular phone according to the third embodiment of the present invention. Referring to FIG. 3, now a person is going to go to cinema to see movies. The person buys a ticket and then enters the cinema to see movies. When the person approaches the entrance, the RFID tag at the entrance will transmits a fourth RF signal (S300). Depending on different types of the RFID tag, the fourth RF signal may be transmitted actively by an active RFID tag, or may be transmitted by a passive RFID tag in response to the received RF signal sent by the cellular phone.

After receiving the fourth RF signal (S310), the cellular phone can obtain the control command according to the RF signal (S320). The method of obtaining the control command is, for example, to translate the fourth RF signal into the identification code, then to search for the control command corresponding to the identification code in the database of the cellular phone, or directly translates the fourth RF signal as the control command.

After the control command is obtained, the cellular phone automatically adjusts to a silent mode according to the command (S330), thus preventing the cellular phone from ringing and disturbing the quiet atmosphere of cinema while movie is playing. Of course, the control command may also instruct the cellular phone to turn off directly or to adjust itself to a vibrate mode which also keeps the cinema quiet.

To sum up, through the handheld communication apparatus control method of the present embodiment, user can enters cinema with peace of mind as usual, without worrying about the cellular phone may ring suddenly while movie is playing, which is very convenient. Of course, the cinema example is only an embodiment of the present invention, other examples may include: the use in the airport, where the RFID tag controls the cellular phones to turn off automatically; the use in a hospital, where the RFID tag at the entrance may automatically adjust the cellular phones to the silent mode or to turn the cellular phones off before entering the medical clinics or wards; and the use when attending important meetings, where the cellular phones are adjusted to the vibrate mode before entering a meeting room. Similar examples are too numerous to mention one by one, however, without departing from the spirit of the present invention, each example may be considered as one of the applications of the present invention.

### The Fourth Embodiment

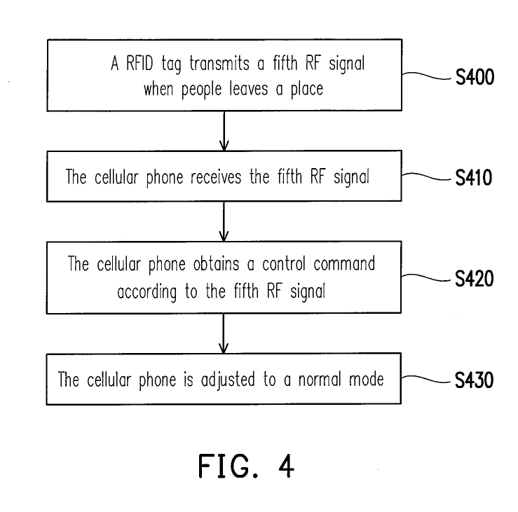

FIG. 4 is a flow chart illustrating a cellular phone control method according to the fourth embodiment of the present invention. Referring to FIG. 4, the present embodiment is extended from the third embodiment. The present embodiment is the detailed steps of restoring the cellular phone back to the normal mode from the silent mode when people finishes seeing the movie and prepares to leave.

To be Specific, after the movie is finished, when the people leave the cinema via the exit, the RFID tag at the entrance/exit may transmit a fifth RF signal to the cellular phone (S400). In the present embodiment, the RFID tag may be a passive RFID tag or an active RFID tag, and the related art of the fifth RF signal transmitted by the RFID tag is same as the previous embodiment. Therefore, the detail of the step (S400) of the present embodiment is omitted here.

Next, after receiving the fifth RF signal (S410), the cellular phone may obtain the control command according to the RF signal (S420). After the control command is obtained, the cellular phone may be adjusted from the silent mode to the normal mode according to the instruction thereof (S430). That means the speaker of the cellular phone is turned on so that the cellular phone can ring again.

To compare the above third and the fourth embodiments, the third embodiment is suitable for use in the situations of entering cinemas, concert halls, and theaters or boarding flights, where the cellular phone is adjusted to the silent mode, vibrate mode or is turned off. The fourth embodiment is to turn the cellular phone from the above modes back to the normal mode when leaving cinemas, concert halls or theater, so that the cellular phone can ring again.

### The Fifth Embodiment

FIG. 5 is a flow chart illustrating a cellular phone control method according to the fifth embodiment of the present invention. Referring to FIG. 5, the present embodiment combines the steps of receiving the fourth RF signal, adjusting to the silent mode or turning off the cellular phone in the third embodiment, and the steps of receiving the fifth RF signal, resuming to the normal mode in the fourth embodiment, such that all the flows of the implementation of the present invention are completely described.

For example, when a person enters a cinema to see movies, the first RFID tag at the cinema entrance/exit transmits a fourth RF signal to the people's cellular phone actively or passively (S500). At this moment, when the fourth RF signal is received by the cellular phone (S502), a control command is obtained according to the fourth RF signal (S504). Then, according to the instruction of the control command, the cellular phone automatically adjusts to the silent mode (S506).

When the movie is finished and the people come to the exit to leave, the second RFID tag transmits a fifth RF signal to the cellular phone actively or passively (S508). Next, after the fifth RF signal is received (S510), the cellular phone obtains the control command according to the fifth RF signal (S512), so as to resume the operation mode thereof back to the normal mode (S514).

Base on the above descriptions, the first and the second RFID tags both may be active RFID tags or passive RFID tags, however the functions of first and the second RFID tags are different. The fourth RF signal transmitted by the first RFID tag is to adjust the cellular phone to the silent mode, while the fifth RF signal transmitted by the second RFID tag is to turn the cellular phone back to the normal mode.

In addition, in the present embodiment, the first RFID tag and the second RFID tag may also be combined into one RF control device which can transmit the fourth and the fifth RF signals. Before entering the cinema, the cinema staff adjusts the RF control device so that it transmits the fourth RF signal. When the movie is almost finished, the cinema staff adjusts the RF control device again, so that it transmits the fifth RF signal. Thus the numbers of the RFID tags used can be reduced.

In the above embodiment, the handheld communication apparatus may further comprises a first control module which is used to control the handheld communication apparatus whether to transmit RF signals to a RFID tag, for example, to control the handheld communication apparatus whether to transmit RF signals to a passive RFID tag.

In the above embodiment, the handheld communication apparatus may further include a second control module which is used to control the handheld communication apparatus whether to receive RF signal transmitted by a RFID tag. The RF signal is, for example, a responding RF signal transmitted by a passive RFID tag after the RF signal transmitted by a RFID tag is received.

In the above embodiment, the handheld communication apparatus may further include a third control module which is used to control the handheld communication apparatus whether to receive the RF signal transmitted by a RFID tag. The RF signal is, for example, a RF signal transmitted by an active RFID tag.

To sum up, the handheld communication apparatus control method at least has the following advantages: Upon entering the specific places, the handheld communication apparatus is turned off or turned to the silent mode automatically by the RFID tag, so that people don't have to worry about that the handheld communication apparatus may suddenly ring or harm flight safety. Upon leaving the above places, the handheld communication apparatus is turned back to the normal mode by the RFID tag, so that people don't have to perform complicated procedures to adjust the handheld communication apparatus.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A handheld communication apparatus control method, suitable for using in a handheld communication apparatus, comprising:
the handheld communication apparatus transmitting a first RF signal to a RFID tag;
the RFID Tag transmitting a second RF signal after receiving the first RF signal;
the handheld communication apparatus receiving the second RF signal;
the handheld communication apparatus obtaining a control command according to the second RF signal; and
the handheld communication apparatus executing an action according to the control command.

2. The handheld communication apparatus control method of claim 1, wherein the step of obtaining the control command comprises:
the handheld communication apparatus translating the second RF signal into an identification code; and
the handheld communication apparatus searching for the control command corresponding to the identification code in its internal database.

3. The handheld communication apparatus control method of claim 1, wherein the step of obtaining the control command comprises:
the handheld communication apparatus translating the second RF signal directly into the control command.

4. The handheld communication apparatus control method of claim 1, wherein the handheld communication apparatus transmits the first RF signals continuously.

5. The handheld communication apparatus control method of claim 1, wherein the handheld communication apparatus transmits the first RF signal every a predetermined time interval.

6. The handheld communication apparatus control method of claim 5, wherein the predetermined time interval is between 1 second to 10 seconds.

7. The handheld communication apparatus control method of claim 1, wherein the RFID tag comprises a passive RFID tag.

8. The handheld communication apparatus control method of claim 1, wherein the method of executing the action includes turning on the speaker of the handheld communication apparatus, turning off the speaker or turning off the handheld communication apparatus.

9. The handheld communication apparatus control method of claim 1, wherein the frequencies of the first RF signal and the second RF signal are between 125 KHz to 2.5 GHz.

10. The handheld communication apparatus control method of claim 1, wherein the handheld communication apparatus comprises a first control module used to control the handheld communication apparatus to determine whether to transmit the first RF signal to the RFID tag.

11. The handheld communication apparatus control method of claim 1, wherein the handheld communication apparatus comprises a second control module used to control the handheld communication apparatus to determine whether to receive the second RF signal.

12. A handheld communication apparatus control method, suitable for using in a handheld communication apparatus, wherein the handheld communication apparatus control method comprises the following steps:
the handheld communication apparatus receiving a RF signal actively transmitted by the RFID tag;
the handheld communication apparatus obtaining a control command according to the RF signal; and
the handheld communication apparatus executing an action according to the control command.

13. The handheld communication apparatus control method of claim 12, wherein the steps of obtaining the control command comprise:
the handheld communication apparatus translating the RF signal into an identification code; and
the handheld communication apparatus searching for the control command corresponding to the identification code in its internal database.

14. The handheld communication apparatus control method of claim 12, wherein the step of obtaining the control command comprises:
the handheld communication apparatus translating the RF signal directly into the control command.

15. The handheld communication apparatus control method of claim 12, wherein the RFID tag transmits the RF signals continuously.

16. The handheld communication apparatus control method of claim 12, wherein the RFID tag transmits the RF signals every a predetermined time interval.

17. The handheld communication apparatus control method of claim 12, wherein the RFID tag comprises an active RFID tag.

18. The handheld communication apparatus control method of claim 12, wherein the method of executing the actions comprises turning off the speaker of the handheld communication apparatus, turning on the speaker or turning off the handheld communication apparatus.

19. The handheld communication apparatus control method of claim 12, wherein the frequency of the RF signal is between 125 KHz to 2.5 GHz.

20. The handheld communication apparatus control method of claim 12, wherein the handheld communication apparatus comprises a control module used to control the handheld communication apparatus to determine whether to receive the RF signal transmitted from the RFID tag actively.
